(19) United States
(12) Patent Application Publication
(10) Pub. No.: US 2016/0135118 A1
(43) Pub. Date: May 12, 2016

(54) OBTAINING INFORMATION FROM A NETWORK SOURCE WITH LIMITED ACCESS

(71) Applicant: Nearzilla, Inc., Redwood City, CA (US)

(72) Inventor: lrina ANIKINA, Redwood City, CA (US)

(21) Appl. No.: 14/937,031

(22) Filed: Nov. 10, 2015

Related U.S. Application Data
(60) Provisional application No. 62/077,740, filed on Nov. 10, 2014.
(60) Provisional application No. 62/160,601, filed on May 13, 2015.

(51) Int. Cl. H04W 48/16; H04W 4/02; H04W 64/00

(52) U.S. Cl. CPC H04W 48/16; H04W 64/00; H04W 4/02; H04W 84/12

(57) ABSTRACT

A mobile communications device is configured to detect one or more radio signals emitted by local Wi-Fi routers and the unique identifier associated with each Wi-Fi router. The mobile communications device searches for the unique identifier in a database of registered Wi-Fi routers. If the unique identifier is found in the database, then content including a resource locator is retrieved and displayed. When the resource locator is selected, the mobile communications device is redirected to the resource locator.

### CROSS-REFERENCE TO RELATED APPLICATIONS

This application claims the benefit of U.S. Provisional Application No. 62/077,740, filed Nov. 10, 2014, and U.S. Provisional Application No. 62/160,601, filed May 13, 2015, both of which are hereby incorporated by reference in their entirety.

### TECHNICAL FIELD

This disclosure relates to having a mobile application that communicates with a content source via a radio signal such as Wi-Fi and/or GPS, where access to the content source is limited by time and position of the mobile device relative to the content source.

### BRIEF DESCRIPTION OF THE DRAWINGS

FIG. 1 is a flow diagram illustrating a process for operating a wireless network to obtain content using Wi-Fi and/or GPS methods.

FIG. 2 is a flow diagram of a process for operating a wireless network system to obtain content via Wi-Fi methods.

FIG. 3 is a flow diagram of a process for operating a wireless network system to obtain content via GPS methods.

FIG. 4 is a flow diagram illustrating a use case for the user of a mobile communications device.

FIG. 5 is one example of a display screen for a mobile communications device.

### DETAILED DESCRIPTION

A mobile application network is disclosed that is configured to obtain information and content through a radio signal, such as Wi-Fi, or via a GPS signal. In the case of communication of the mobile device through Wi-Fi, the signals are obtained from a self-contained Wi-Fi router not connected to the Internet. In the case of communication through GPS coordinates, the GPS coordinates are obtained from a GPS coordinate database according to methods known in the art.

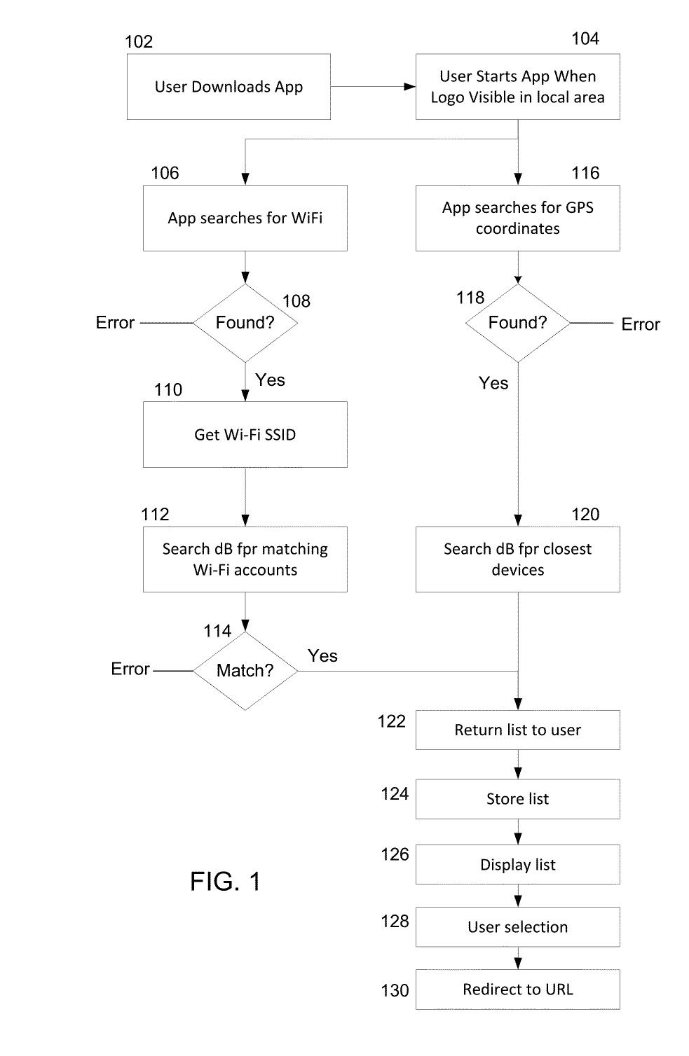

FIG. 1 is a flow chart illustrating a process 100 that enables the user of a mobile communications device, such as a smartphone, to obtain information or content from a content source having limited access to Internet or other online services. In a preliminary step 102, in order to access the application services described herein, the user downloads and installs a first application to the user's mobile communications device. As part of the download and installation process, the first application generates a distinctive icon or logo to represent the application and places the icon on a display screen of the mobile device in the usual manner associated with such devices.

In step 104, the user activates the first application upon seeing the logo associated with the first application displayed on an object located within the field of vision of the user, wherever he or she might be. The object could be almost anything, and could be fixed in place, such as a billboard, a house, a restaurant, etc., or the object could be moving, e.g., affixed to a passing vehicle, such as a taxicab or a bus, etc. The first application may be activated in any well-known manner, for example, by tapping on the icon as displayed on the mobile device, or through a voice command feature of the device.

The first application then performs several steps in parallel, with one path (steps 106-114) directed to detecting the radio signals of local area sources of Wi-Fi signals, and a second path (steps 116-120) directed to identifying local area sources of Wi-Fi signals based on the detected location of the user's device, for example, in terms of GPS coordinates.

In step 106, the first application searches for radio signals that identify local Wi-Fi network(s). If one or more local Wi-Fi network(s) is found in step 108, then the identification of each Wi-Fi source device, e.g., the unique device ID, is obtained from the Wi-Fi source device in well-known manner in step 110. The unique ID of each Wi-Fi device is then checked against a database of registered Wi-Fi devices in step 112, and if there is a match in the database for any of the Wi-Fi devices, then the presence and identity of those devices is returned to the user in a list format in step 122, which is stored in the mobile device in step 124, then displayed on a screen of the mobile device in step 126. For example, the list may contain the location name and/or device name, with a link to share the content and a short description of the device and its location. In one embodiment, the first application also determines the signal strength for each Wi-Fi source device identified in the local area. The signal strength information can be used to help search the database of local registered Wi-Fi devices, and the list of device can then be presented in order from the strongest signal to the weakest signal.

In similar and parallel manner, the first application also searches to obtain GPS information in order to identify the location of the user's mobile device in step 116. It the GPS information is obtained in step 118, then in step 120, the database of registered devices is searched to identify the devices located closest to the user's mobile device location. In step 122, the two parallel paths come back together, and as described above, a list of nearby objects of interest is returned to the user in a list format, stored in step 124, and displayed in step 126.

In one embodiment, the list delivered to the user device shows up to five of the nearest Wi-Fi networks and/or up to five of the nearest GPS locations for objects of interest associated with the network. If the Wi-Fi network is unavailable, then the list will only include the GPS location of the device, and vice versa.

In step 128, the user selects one of the Wi-Fi devices listed on the display, and in step 130, the user device is redirected to a URL associated with the selected Wi-Fi device.

As can be appreciated, the steps relating to Wi-Fi and GPS applications are generally the same, except that the Wi-Fi signals relate to the SSID of the router(s), while the GPS coordinates are obtained through a space-based satellite navigation system that provides the location of the mobile device and the nearest objects of interest that have been added to the database of registered devices that is utilized for the network described herein.

In some embodiments, the network may not necessarily be linked to a combined use of both Wi-Fi and GPS methods and may be used solely with either Wi-Fi or GPS methods.

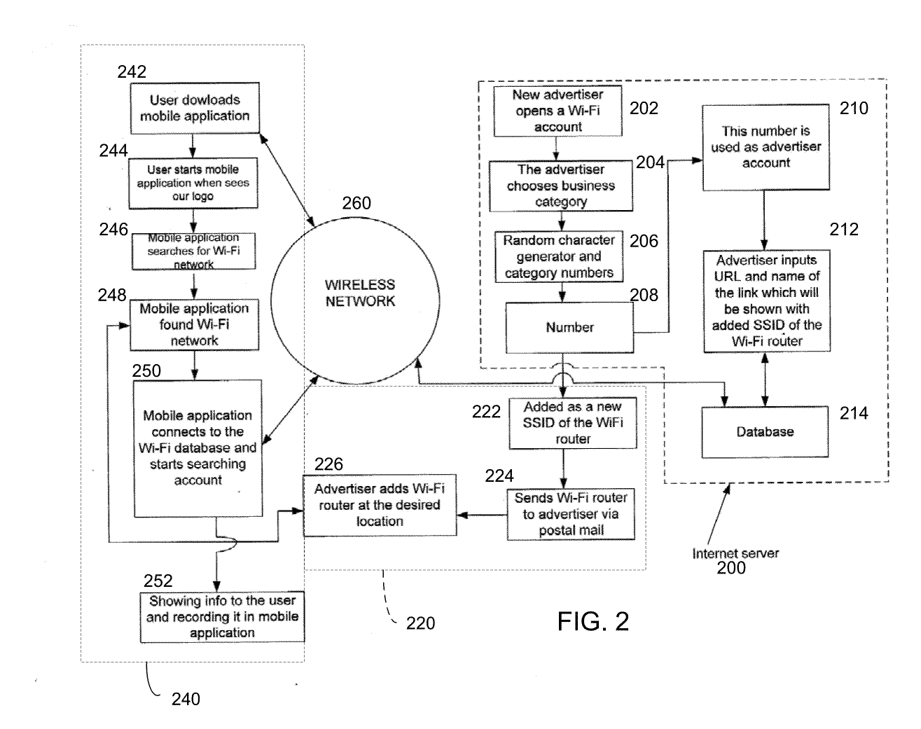

FIG. 2 illustrates the processes that take place in server 200, a typical router device 220, and the user's mobile communications device 240, in order to operate the mobile application network 260 in connection only with the Wi-Fi application network. The mobile application network consists of an information source which may be stationary or mobile, and which is provided with a self-contained Wi-Fi router 220 not connected to the Internet, such as the VAR11N-300 mini Wi-Fi router/repeater/bridge, but containing an alpha-numeric code associated with an account that has been created on a server 200. The server 200 is configured to include a database (which may be a company name or project name added by an advertiser), and a random character generator.

In step 202, an advertiser opens a new Wi-Fi account on the server 200. In step 204, the advertiser chooses a business category, such as real estate, landscaping, restaurant, outdoor advertising, etc. In step 206, the random character generator randomly generates alpha-numeric characters and category numbers. In step 208, the randomly generated characters are assigned as the unique ID for this specific Wi-Fi network. This step is necessary to select the specific Wi-Fi network from other neighboring networks having other Wi-Fi codes that have no relation to the mobile application network described herein. In step 210, this number is also used as the account number for the advertiser. In step 212, the advertiser inputs all the relevant information, including the associated URL and the name of the link, and in step 214, this information is stored in the database.

In one embodiment, the random generator uses the first 5-10 characters of the router device SSID for identification and selection of the specific Wi-Fi network. The standard length of an SSID should be a 32 characters maximum (32 octets, normally ASCII letters and digits, although the standard does not exclude simple numerical values).

As noted above, the alpha-numeric Wi-Fi ID also contains information about the account opened by the advertiser on the server. In step 222, the alpha-numeric Wi-Fi ID is added to the Wi-Fi router, and the router is then sent to the advertiser, e.g., by post, in step 224. In step 226, the advertiser physically installs the Wi-Fi router(s) in predetermined locations, such as billboards, on buses, in popular tourist places, hotels, restaurants, food trucks, and other visible advertising sources.

If the user of a mobile communications device, such as a smart phone, tablet, or the like, wishes to obtain content or information on the basis of a visually logo indicating that the mobile application network is available, the user must first download and install the mobile network application into their mobile device in step 242. As part of the installation process, an appropriate icon or logo associated with the downloaded network application will appear on a display screen of the mobile device.

When the user passes by an object bearing the network logo, for example, by driving a car on the freeway and seeing the network logo on a billboard, in step 244, the user taps the network logo on the display screen of their mobile communication device, and the alpha-numeric Wi-Fi ID of the network router will instantly connect to the server that maintains the advertiser's account. Since a link to the server remains on the mobile communication device even when the user leaves the local zone of Wi-Fi source, the user can later connect to the server by clicking on that link. Thus, the user does not need to remove his or her attention from driving, or follow the mobile source, and can instead safely obtain the information in a shared-time mode.

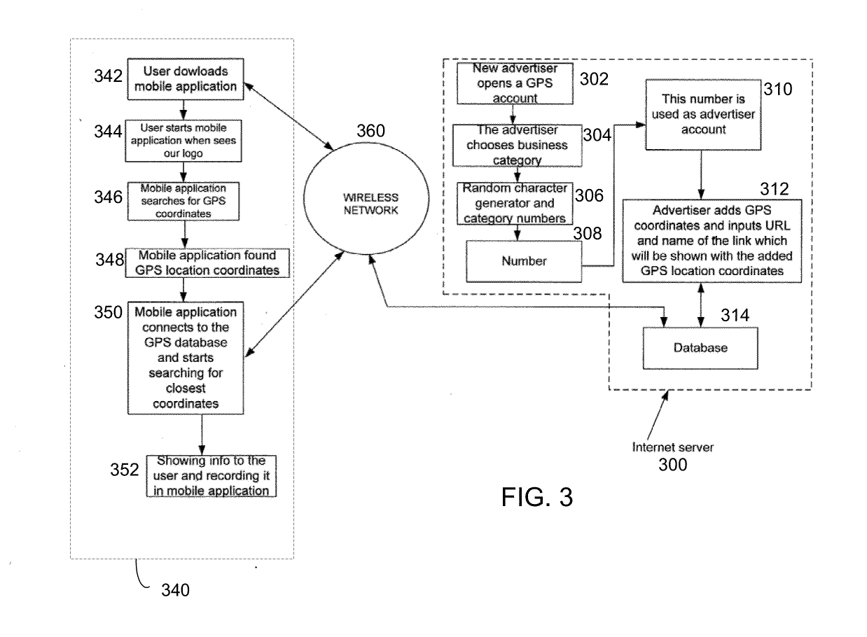

FIG. 3 illustrates the processes that take place in server 300 and the user's mobile communications device 340, in order to operate the mobile application network 360 in connection only with the GPS application. In step 302, an advertiser opens a new GPS account on the server 300. In step 304, the advertiser chooses a business category. In step 306, the random character generator randomly generates alpha-numeric characters and category numbers, and in step 308, the randomly generated characters are assigned as the unique ID for this specific Wi-Fi network. In step 310, this number is also used as the account number for the advertiser.

In step 312, the advertiser inputs all the relevant information, including the GPS coordinates, the associated URL, and the name of the link, and in step 314, this information is stored in the database.

In step 342, the user downloads the GPS mobile application. In step 344, the user starts the mobile application on the user device. In step 346, the GPS application searches for the GPS coordinates of the mobile device, and when found in step 348, the GPS application searches for the nearest objects of interests in step 350. The results of the search are shown on the screen of the mobile device and recorded in the mobile application for the future use in step 352.

Many commercial and public transportation vehicles are already equipped with a GPS device. Similar to associating URL's with existing SSID's, URL's can also be associated with commercial and public transportation vehicles which are provided with GPS devices. In other words, the existing GPS tracking software can also be used for finding GPS coordinates of up to five of the nearest objects of interest which have been registered with the mobile application network.

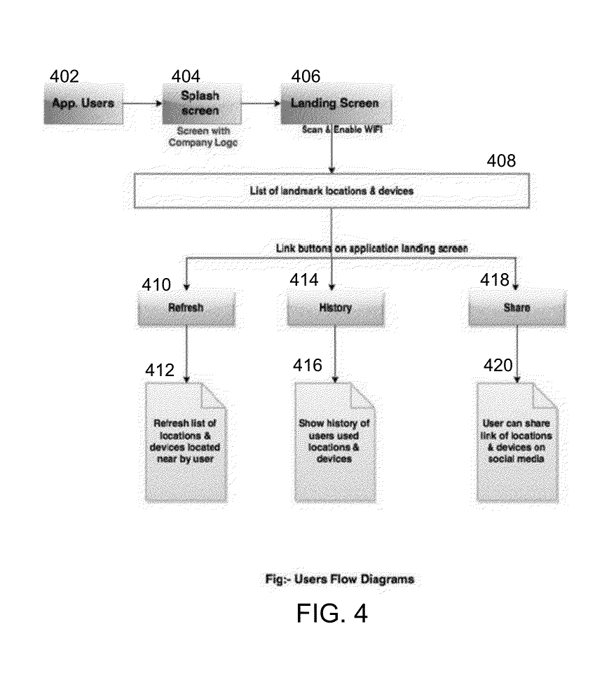

Referring now to FIG. 4, a process 400 is shown that represents a use case for mobile device users. In step 402, the user runs the mobile application. In step 404, the application briefly displays a “splash screen” on the mobile device, i.e., a screen that displays the network logo. In step 406, the application displays a “landing screen” on the mobile device. The landing screen is the main display screen of the mobile application, and when the landing screen is displayed, the application will immediately being to scan and enable Wi-Fi, and then list landmark locations and devices on the display screen of the user device in step 408.

The mobile application configures the user device with link buttons on the landing screen that provide basic functionality within the mobile network application. For example, selecting a “refresh” button in step 410 causes the list of nearby locations and devices to be refreshed on the display of the user's device in step 412. Selecting a “history” button in step 414 causes a history of the nearby locations and devices as used by the user to be displayed of the user's device in step 416. Selecting a “share” button in step 418 allows the user to share the link of nearby locations and devices on social media in step 420.

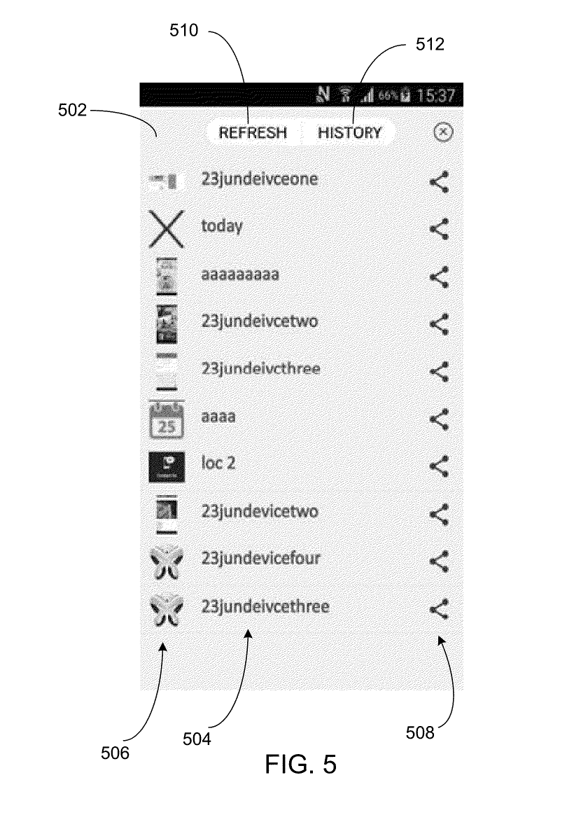

FIG. 5 illustrates one example of a landing screen 502 on the user device. The landing screen 502 includes a listing 504 of the device name and/or the location name. For example, the devices may be listed in order of received signal strength. An image 506 is associated with each line item in the listing. A “share” icon 508 is included next to each line item to enable sharing the link to the device name and/or the location name on social media.

A refresh button 510 is provided to cause an immediate refresh of the display screen when selected. A history button 512 is provided to cause a display of the user's history for devices and locations when selected.

Many of the digital components described herein are well known, and the methods for programming such digital component are also well known. In a typical computer network environment, a number of client devices may be coupled to a server system via a communications network and communication links. The communications network provides a mechanism for allowing the various client devices to communicate and exchange information with each other and with the server.

A communications network may itself be comprised of many interconnected computer systems and communication links. The communication links may be hardwired links, optical links, satellite or other wireless communications links, wave propagation links, or any other mechanisms for communication of information. Various communication protocols may be used to facilitate communication, including TCP/IP, HTTP protocols, wireless application protocol (WAP), vendor-specific protocols, customized protocols, Internet telephony, IP telephony, digital voice, voice over broadband (VoBB), broadband telephony, Voice over IP (VoIP), public switched telephone network (PSTN), and others. While in one embodiment, the communications network is the Internet, in other embodiments, the communication network may be any suitable communication network including a local area network (LAN), a wide area network (WAN), a wireless network, a intranet, a private network, a public network, a switched network, and combinations of these, and the like.

Client systems enable users to access and query information or applications stored by a server system. Some example client systems include portable electronic devices (e.g., mobile communication devices, smartphones, tablet computers, laptops) such as the Samsung Galaxy Tab®, Google Nexus devices, Amazon Kindle®, Kindle Fire®, Apple iPhone®, the Apple iPad®, Microsoft Surface®, the Palm Pre™, or any device running the Apple iOS™, Android™ OS, Google Chrome OS, Symbian OS®, Windows Mobile® OS, Windows Phone, BlackBerry OS, Embedded Linux, webOS, Palm OS® or Palm Web OS™.

In a specific embodiment, a web browser application executing on a client system enables users to select, access, retrieve, or query information and/or applications stored by a server system. Examples of web browsers include the Android browser provided by Google, the Safari® browser provided by Apple, Amazon Silk® provided by Amazon, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others (e.g., Google Chrome).

A mobile communications device typically includes a display, screen, or monitor, a housing, and input device(s). The housing contains familiar computer components, such as a processor, memory, battery, speaker, transceiver, antenna, microphone, ports, jacks, connectors, camera, input/output (I/O) controller, display adapter, network interface, mass storage devices, and the like.

Mass storage devices may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

A computer-implemented or computer-executable version of the program instructions useful to practice the systems and techniques described in this application may be embodied using, stored on, or associated with a computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software useful to practice the techniques described in this application may be stored or reside in RAM or cache memory, or on mass storage device. The source code of this software may also be stored or reside on mass storage device (e.g., flash drive, hard disk, magnetic disk, tape, or CD-ROM). As a further example, code useful for practicing the techniques described in this application may be transmitted via wires, radio waves, or through a network such as the Internet. In another specific embodiment, a computer program product including a variety of software program code to implement features described in this application is provided.

Computer software products may be written in any of various suitable programming languages, such as C, C++, C#, Pascal, Fortran, Perl, Matlab (from MathWorks, www.mathworks.com), SAS, SPSS, JavaScript, CoffeeScript, Objective-C, Objective-J, Ruby, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Windows Phone, Symbian, BlackBerry OS, Palm web OS, bada, Embedded Linux, MeeGo, Maemo, Limo, or Brew OS. Other operating systems may be used.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system useful in practicing the systems and methods in this application using a wireless network employing a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

The description herein is not intended to be limiting, and many changes and modifications are possible without deviation from the spirit of the disclosure. The routers of the network can be rented from the mobile application network owner and placed, e.g., in big shopping centers for access to the information about the products of the shopping center, for example, coupons, etc. Alternatively, the mobile application network can be conveniently used by real estate agents. The use of the network reduces paperwork such printing ads on paper, screening of business cards, storage of hard-copy ads, etc. If necessary, the link to the Internet server may be accompanied by audio information which can be heard by the user while driving. Thus, the system is convenient for use when access to the information is limited by time and position of the user relative to the information source. The user is not necessarily mobile, but can stay in a position stationary relative to a stationary source of Wi-Fi signals. For the same ad, a plurality of routers can be used with the same ID. Instead of a Wi-Fi router, a user may configure the mobile phone as a hotspot with the SSID of the network by sending a number generated by the network via email.

1. A method, comprising:
scanning the local area with a mobile communications device in order to detect at least one radio signal associated with at least one Wi-Fi router;
obtaining, by the mobile communications device, the unique identifier for the Wi-Fi router;
searching for the unique identifier in a database of registered Wi-Fi routers;
receiving and displaying, at the mobile communications device, content including a resource locator associated with the at least one Wi-Fi router when the unique identifier is found in the database;
receiving, at the mobile communications device, a selection of the resource locator associated with the at least one Wi-Fi router; and
in response to the selection, redirecting the display of the mobile communications device to the content associated with the resource locator of the at least one Wi-Fi router.

2. The method of claim 1, further comprising:
detecting a first plurality of Wi-Fi routers in the local area;
matching a subset of the first plurality of Wi-Fi routers in the search of the database;
displaying the subset of the first plurality of Wi-Fi routers on the mobile communications device; and
receiving a selection of one of the subset of the first plurality of Wi-Fi routers.

3. The method of claim 2, further comprising:
obtaining the geographic location of the mobile communications device;
identifying a second plurality of Wi-Fi routers in the database of registered Wi-Fi routers that are located within a set distance from the geographic location of the mobile communications device; and
displaying a list of the first plurality of Wi-Fi routers and the second plurality of Wi-Fi routers on the mobile communications device; and
receiving a selection of a single Wi-Fi router from the list of the first and second plurality of Wi-Fi routers.

4. The method of claim 1, further comprising:
identifying a logo affixed to a device within the local area, the logo associated with a network source for content;
activating an application associated with the network source for content on the mobile communications device; and
using the application to carry out the steps recited in claim 1.

5. The method of claim 1, further comprising:
storing the content including the resource identifier associated with the at least one Wi-Fi router; and
selecting the resource identifier associated with the at least one Wi-Fi router at a later time.

6. The method of claim 1, further comprising:
storing a history of resource identifiers selected by a user.

7. The method of claim 1, further comprising:
sharing the content and associated resource identifier with other users.

8. The method of claim 1, further comprising:
identifying an account associated with a particular Wi-Fi router;
assigning a unique identifier to the particular Wi-Fi router; and
deploying the particular Wi-Fi router in the local area.

9. The method of claim 8, further comprising:
associating content and a resource identifier with the particular Wi-Fi router.

10. A mobile communications device, comprising:
at least one processor running an application to process Wi-Fi router signals; and
a memory coupled to the processor and having a plurality of instructions executable by the processor, the instructions, when executed by the processor, cause the processor to:
scan the local area with the mobile communications device in order to detect at least one radio signal associated with at least one Wi-Fi router;
obtain a unique identifier for the Wi-Fi router from the detected radio signal;
search for the unique identifier in a database of registered Wi-Fi routers;
receive and display content including a resource locator associated with the at least one Wi-Fi router when the unique identifier is found in the database;
receive a selection of the resource locator associated with the at least one Wi-Fi router; and
in response to the selection, redirect the display of the mobile communications device to the content associated with the resource locator of the at least one Wi-Fi router.

11. The mobile communications device of claim 8, further comprising instructions that cause the processor to:
detect a first plurality of Wi-Fi routers in the local area;
match a subset of the first plurality of Wi-Fi routers in the search of the database;
display the subset of the first plurality of Wi-Fi routers on the mobile communications device; and
receive a selection of one of the subset of the first plurality of Wi-Fi routers.

12. The mobile communications device of claim 8, further comprising instructions that cause the processor to:
obtain the geographic location of the mobile communications device;
identify a second plurality of Wi-Fi routers in the database of registered Wi-Fi routers that are located within a set distance from the geographic location of the mobile communications device; and
display a list of the first plurality of Wi-Fi routers and the second plurality of Wi-Fi routers on the mobile communications device; and
receive a selection of a single Wi-Fi router from the list of the first and second plurality of Wi-Fi routers.

13. The mobile communications device of claim 8, further comprising instructions that cause the processor to:
store the content including the resource identifier associated with the at least one Wi-Fi router; and
select the resource identifier associated with the at least one Wi-Fi router at a later time.

14. The mobile communications device of claim 8, further comprising instructions that cause the processor to:
identify an account associated with a particular Wi-Fi router;
assign a unique identifier to the particular Wi-Fi router; and
deploy the particular Wi-Fi router in the local area.

15. The mobile communications device of claim 8, further comprising instructions that cause the processor to:
associate content and a resource identifier with the particular Wi-Fi router.

16. A non-transitory machine-readable medium having stored thereon one or more sequences of instructions for processing Wi-Fi router signals, which instructions, when executed by at least one processor, causes the processor to carry out the steps of:
scanning the local area with the mobile communications device in order to detect at least one radio signal associated with at least one Wi-Fi router;
obtaining a unique identifier for the Wi-Fi router from the detected radio signal;
searching for the unique identifier in a database of registered Wi-Fi routers;
receiving and displaying content including a resource locator associated with the at least one Wi-Fi router when the unique identifier is found in the database;
receiving a selection of the resource locator associated with the at least one Wi-Fi router; and
in response to the selection, redirecting the display of the mobile communications device to the content associated with the resource locator of the at least one Wi-Fi router.

17. The medium of claim 16, further comprising instructions that cause the processor to:
detect a first plurality of Wi-Fi routers in the local area;
match a subset of the first plurality of Wi-Fi routers in the search of the database;
display the subset of the first plurality of Wi-Fi routers on the mobile communications device; and
receive a selection of one of the subset of the first plurality of Wi-Fi routers.

18. The medium of claim 16, further comprising instructions that cause the processor to:
obtain the geographic location of the mobile communications device;
identify a second plurality of Wi-Fi routers in the database of registered Wi-Fi routers that are located within a set distance from the geographic location of the mobile communications device; and
display a list of the first plurality of Wi-Fi routers and the second plurality of Wi-Fi routers on the mobile communications device; and
receive a selection of a single Wi-Fi router from the list of the first and second plurality of Wi-Fi routers.

19. The medium of claim 16, further comprising instructions that cause the processor to:
store the content including the resource identifier associated with the at least one Wi-Fi router; and
select the resource identifier associated with the at least one Wi-Fi router at a later time.

20. The medium of claim 16, further comprising instructions that cause the processor to:
identify an account associated with a particular Wi-Fi router;
assign a unique identifier to the particular Wi-Fi router; and
deploy the particular Wi-Fi router in the local area.
